(19) United States
(12) Patent Application Publication
(10) Pub. No.: US 2016/0013479 A1
(43) Pub. Date: Jan. 14, 2016

(54) Composite Active Material And Method For Producing The Same

(71) Applicant: TOYOTA JIDOSHA KABUSHIKI KAISHA, Toyota-shi (JP)

(72) Inventor: Masahiro IWASAKI, Nagoya-shi (JP)

(73) Assignee: TOYOTA JIDOSHA KABUSHIKI KAISHA, Toyota-shi, Aichi (JP)

(21) Appl. No.: 14/755,319

(22) Filed: Jun. 30, 2015

(30) Foreign Application Priority Data
Jul. 10, 2014 (JP) 2014-142377

(51) Int. Cl. H01M 4/36; H01M 10/052; H01M 10/0562; H01M 4/04

(52) U.S. Cl. CPC H01M 4/366; H01M 4/0471; H01M 4/0402; H01M 10/052; H01M 10/0562; H01M 2300/0071; H01M 2300/0068

(57) ABSTRACT

A method for producing a composite active material includes a preparation step of preparing composite particles comprising active material particles and an oxide solid electrolyte coating at least a part of the surfaces of the active material particles, wherein the active material particles comprise lithium, oxygen and at least one selected from the group consisting of cobalt, nickel, and manganese; and a coating step of mixing the composite particles and a crystalline sulfide solid electrolyte while controlling a temperature of a mixture of the composite particles and the sulfide solid electrolyte to be no greater than 58.6° C. and while applying an energy to the mixture such that the sulfide solid electrolyte undergoes plastic deformation, such that the surfaces of the composite particles are coated with the sulfide solid electrolyte.

### TECHNICAL FIELD

The present invention relates to composite active materials that are generally employed for lithium batteries and thereby make it possible to improve the power of batteries, and relates to a method for producing the composite active materials. The present invention also relates to lithium batteries including the composite active materials.

### BACKGROUND ART

Secondary batteries are batteries that make it possible to convert chemical energy to electrical energy, to discharge electricity. In addition, secondary batteries are batteries that make it possible to convert electrical energy to chemical energy, to store (charge) electricity by currents flowing in the reverse direction of those in discharging. Some kind of secondary batteries that is typified by lithium secondary batteries has high energy density. Thus, it is widely applied to power sources of mobile devices such as notebook personal computers and mobile phones.

In a case where graphite (represented by C) is employed as an anode active material in a lithium secondary battery, the reaction represented by the formula (I) below proceeds at the anode in discharging:

LiₓC₆→6C+xLi⁺+xe⁻ (I)

(in the above formula (I), 0<x<1).

Electrons generated from the reaction of the above formula (I) pass through an external circuit, and after doing work by means of external loads, reach the cathode. Electroendosmosis moves lithium ions (Li⁺) generated from the reaction of the above formula (I) from the anode side to the cathode side in an electrolyte that is clamped by the anode and cathode.

In a case where lithium cobalt oxide (Li₁₋ₓCoO₂) is employed as a cathode active material, the reaction represented by the formula (II) below proceeds at the cathode in discharging:

Li₁₋ₓCoO₂+xLi⁺+xe⁻→LiCoO₂ (II)

(in the above formula (II), 0<x<1).

In charging, the reverse reactions with the above formulas (I) and (II) proceed at the anode and cathode, respectively. At the anode, graphite where lithium is intercalated by graphite intercalation (LiₓC₆) is regenerated, and at the cathode, lithium cobaltates (Li₁₋ₓCoO₂) are regenerated. Thus, it becomes possible to discharge again.

Electrodes used in lithium batteries are important components that determine charge and discharge performance of batteries. Various studies have been done on electrodes. For example, Patent Literature 1 discloses an electrode body that has a positive electrode active material, containing lithium cobalt oxide in which a coating layer containing lithium niobate is formed on at least a part of its surface, and a solid electrolyte containing solid sulfide.

### CITATION LIST

### Patent Literature

Patent Literature 1: JP 2010-073539 A

### SUMMARY OF INVENTION

### Technical Problem

Patent Literature 1 describes that a positive electrode active material where an LiNbO₃ layer is provided with the surface of LiCoO₂ is mixed with Li₇P₃S₁₁ (sulfide solid electrolyte) so as to have the mass ratio of positive electrode active material:solid electrolyte=7:3, to form a positive electrode (paragraph [0038] in the Description of Patent Literature 1). However, as a result of studies of the inventor and so on, it has been made clear that the reaction resistance is high because there are many cathode active materials that do not touch a sulfide solid electrolyte directly at the electrode body as disclosed in Patent Literature 1; and thus it is difficult to improve the power of the battery. The inventor and so on considered coating a cathode active material that has lithium niobate layer with a sulfide solid electrolyte. However, it became clear that the material characteristics got poor in the process of coating with the sulfide solid electrolyte, and the power of the battery is rather reduced.

In view of the above, an object of the present invention is to provide a method for producing composite active materials that are generally employed for lithium batteries and thereby make it possible to improve the power of batteries, and to provide lithium batteries including the composite active materials.

### Solution to Problem

A method for producing a composite active material of the present invention includes a preparation step of preparing composite particles comprising active material particles and an oxide solid electrolyte coating at least a part of the surfaces of the active material particles, wherein the active metal particles comprise lithium, oxygen and at least one selected from the group consisting of cobalt, nickel, and manganese; and a coating step of mixing the composite particles and a crystalline sulfide solid electrolyte while controlling a temperature of a mixture of the composite particles and the sulfide solid electrolyte to be no greater than 58.6° C. and while applying an energy to the mixture such that the sulfide solid electrolyte undergoes plastic deformation, such that the surfaces of the composite particles are coated with the sulfide solid electrolyte.

In the producing method of the present invention, it is preferable that the mixing in the coating step includes a first mixing step of carrying out the mixing under a condition such that the sulfide solid electrolyte undergoes plastic deformation; and a second mixing step of carrying out the mixing under a condition such that the sulfide solid electrolyte does not undergo plastic deformation, and the first mixing step and the second mixing step are alternately carried out.

In the producing method of alternately carrying out the first mixing step and the second mixing step of the present invention, it is preferable that the first mixing step is carried out for no longer than a time T at once in the coating step; and in a curve which is a plot of a temperature increase of the mixture versus an operation time of the first mixing step in a case where only the first mixing step is continuously carried out as the coating step, the time T is an operation time corresponding to an intersection of an extension line of a most rapid temperature increase right after beginning of the coating step and a tangential line which touches the curve at an operation time when the temperature increase per unit time converges.

In the producing method of the present invention, it is preferable that the crystalline sulfide solid electrolyte in the coating step is sulfide solid electrolyte particles having an average particle size of no greater than 1 μm.

In the producing method of the present invention, such a manner can be employed that the coating step further includes the steps of: adding the crystalline sulfide solid electrolyte to the mixture after mixing for 10 minutes or more; and thereafter carrying out the mixing while controlling the temperature of the mixture to be no greater than 58.6° C. and while applying an energy to the mixture such that the sulfide solid electrolyte undergoes plastic deformation.

The producing method of the present invention may further include a pretreatment step of mixing the composite particles and/or the crystalline sulfide solid electrolyte with a compound having an alkyl group, prior to the coating step.

A lithium battery of the present invention includes a cathode; an anode; and an electrolyte layer arranged between the cathode and the anode, wherein the cathode and/or the anode comprises the composite active material produced by the above producing method.

### Advantageous Effects of Invention

According to the producing method of the present invention, produced can be a composite active material that makes it possible to improve power of a lithium battery when used in the battery. According to the lithium battery of the present invention, provided can be a lithium battery whose power is improved by its cathode and/or anode including the composite active material obtained from the producing method of the present invention.

### BRIEF DESCRIPTION OF DRAWINGS

FIGS. 1A to 1D are schematic cross-sectional views of the composite active materials of every embodiment of the present invention.

FIG. 2 is a view depicting an example of a layered structure of the lithium battery of the present invention, which schematically depicts the cross section cut in the layering direction.

FIG. 3 depicts an example of a graph that is a plot of a temperature increase of a mixture against an operation time of the first mixing step in a case where only the first mixing step is continuously carried out as a coating step.

FIG. 4 depicts XRD of a crystalline sulfide solid electrolyte used in Examples and Comparative Examples.

FIG. 5A depicts an example of an SEM image (reflection electron image) on which it can be perceived that a sulfide solid electrolyte is attached to the surface of a composite particle as is the form of particles; and FIG. 5B depicts an example of an SEM image (reflection electron image) on which it can be perceived that a sulfide solid electrolyte undergoes plastic deformation on the surface of a composite particle from the form of particles to the form of films.

FIG. 6A is an SEM image (reflection electron image) of the composite active material particles of Example 1; FIG. 6B is an SEM image (reflection electron image) of the composite active material particles of Example 4; FIG. 6C is an SEM image (reflection electron image) of the composite active material particles of Example 5; FIG. 6D is an SEM image (reflection electron image) of the composite active material particles of Example 6; and FIG. 6E is an SEM image (reflection electron image) of the composite active material particles of Comparative Example 3.

### DESCRIPTION OF EMBODIMENTS

<1. Method for Producing Composite Active Material>

The method for producing a composite active material of the present invention includes a preparation step of preparing composite particles comprising active material particles and an oxide solid electrolyte coating at least a part of the surfaces of the active material particles, wherein the active metal particles comprise lithium, oxygen and at least one selected from the group consisting of cobalt, nickel, and manganese; and a coating step of mixing the composite particles and a crystalline sulfide solid electrolyte while controlling a temperature of a mixture of the composite particles and the sulfide solid electrolyte to be no greater than 58.6° C. and while applying an energy to the mixture such that the sulfide solid electrolyte undergoes plastic deformation, such that the surfaces of the composite particles are coated with the sulfide solid electrolyte.

The method for producing a composite active material of the present invention includes (1) a preparation step of preparing a composite particle and (2) a coating step of coating the surfaces of the composite particle with a crystalline sulfide solid electrolyte. The present invention is not necessarily limited to a mode only consisting of the above two steps. For example, a pretreatment step as described below and so on may be included other than the above two steps.

The above steps (1) and (2) and other steps will be explained below in order.

(1-1. Preparation Step)

This step is a step of preparing the above composite particle. The composite particle includes active material particles and an oxide solid electrolyte that coats at least a part of the surfaces of the active material particles.

The active material particles are compound particles that include lithium (Li), oxygen (O) and at least one selected from the group consisting of cobalt (Co), nickel (Ni) and manganese (Mn). Employed without any limitation can be active material particles that function as electrode active materials, specifically, that is possible to occlude and/or emit ions including lithium ions. Examples of active material particles that can be employed in the present invention include active material particles represented by the composition formula (A) below:

LiₘNi_{1-x-y}CoₓMn_{y}M_{z}Oₙ Composition Formula (A)

(in the above composition formula (A), M is at least one element selected from the group consisting of phosphorus (P), titanium (Ti), tungsten (W) zirconium (Zr) and aluminum (Al); m is a real number that satisfies 0<m≦2; x and y are real numbers that satisfy 0≦x≦1 and 0≦y≦1, respectively; z is a real number that satisfies 0<z≦2; and n is a real number that satisfies 0<n≦4).

Concrete examples of the active material particles include layered cathode active materials such as LiCoO₂, LiNiO₂, LiNi_{1/3}Co_{1/3}Mn_{1/3}O₂, LiVO₂ and LiCrO₂; spinel type cathode active materials such as LiMn₂O₄, Li(Ni_{0.25}Mn_{0.75})₂O₄, LiCoMnO₄ and Li₂NiMn₃O₈; polyanion cathode active materials such as olivine type cathode active materials such as LiCoPO₄, LiMnPO₄, LiNiPO₄ and LiFePO₄, and Li₂NiTiO₄; and NASICON type cathode active materials such as Li₃V₂P₃O₁₂. Especially, it is preferable to use LiNi_{1/3}Co_{1/3}Mn₃O₂ among these active material particles.

The active material particles may be single crystalline active material particles, and may be a polycrystalline active material particle that is composed of a plurality of single crystals of active materials bonding each other on their crystal face.

The average particle size of the active material particles is not especially limited as long as being under the average particle size of an aimed composite active material. However, it is preferable that the average particle size of the active material particles is in the range from 0.1 to 30 μm. It is noted that in a case where the active material particles are a polycrystalline active material particle that is composed of a plurality of crystals of active materials bonding each other, the average particle size of the active material particles refers to the average particle size of the polycrystalline active material particle.

The average particle size in the present invention is calculated by a usual way. An example of the way of calculating the average particle size is as follows: first, on a transmission electron microscope (hereinafter referred to as “TEM”) image or a scanning electron microscope (hereinafter referred to as “SEM”) image with a proper magnification (for example, magnification from fifty thousands to million times), the particle size of one particle in a case where this particle is assumed to be a spherical shape (equivalent spherical diameter) is calculated. That is, an area on the image which the particle occupies is measured, and a diameter of a circle that has an area equivalent to the area occupied by the particle is calculated as the particle size of the particle (equivalent spherical diameter). Such calculation of the particle size through TEM observation or SEM observation is carried out on 200 to 300 particles of the same kind, and the average of these particles is assumed to be the average particle size.

The oxide solid electrolyte is not especially limited as long as containing oxygen (O) and having a chemical affinity for the active material particles so as to be possible to coat at least a part of the surfaces of the active material particles. Examples of the oxide solid electrolyte include that represented by the general formula, LixAOy (here, A is one selected from the group consisting of B, C, Al, Si, P, S, Ti, Zr, Nb, Mo, Ta and W; and x and y are positive real numbers). Concrete exemplifications of the oxide solid electrolyte include Li₃BO₃, LiBO₂, Li₂CO₃, LiAlO₂, Li₄SiO₄, Li₂SiO₃, Li₃PO₄, Li₂SO₄, Li₂TiO₃, Li₄Ti₅O₁₂, Li₂Ti₂O₅, Li₂ZrO₃, LiNbO₃, Li₂MoO₄, Li₂WO₄, LiPON (lithium phosphorous oxynitride), L_{1.3}Al_{0.3}Ti_{1.7}(PO₄)₃ and La_{0.51}Li_{0.34}TiO_{2.94}. Especially, it is preferable that LiNbO₃ is used among these oxide solid electrolytes.

It is preferable that the thickness of an oxide solid electrolyte layer on the composite particles is in the range from 1 nm to 100 nm. If the oxide solid electrolyte layer is too thick, there is a risk of the reduction of the power of a battery. Thus, it is preferable that the oxide solid electrolyte layer is as thin as possible, and the coverage of the oxide solid electrolyte layer over the surfaces of the active material particles is high. On the contrary, if the oxide solid electrolyte layer is too thin, there might exist a part of the surfaces of the active material particles which is not coated with the oxide solid electrolyte layer. As a result, the active material particles might touch the sulfide solid electrolyte, to react and deteriorate.

The average thickness of the solid electrolyte layer (oxide solid electrolyte layer and sulfide solid electrolyte layer) in the present invention is calculated by a usual way. An example of the way of calculating the average thickness of the solid electrolyte layer is as follows: first, on a TEM image or SEM image with a proper magnification (for example, magnification from fifty thousands to million times), the thickness of the solid electrolyte layer on one particle (composite particle or composite active material particle) is measured at five to ten points. Such measurement of the thickness through TEM observation or SEM observation is carried out on 200 to 300 particles of the same kind, and the average of all the measured thickness concerning these particles is assumed to be the average thickness.

In the composite active material produced by the producing method of the present invention, the oxide solid electrolyte is arranged between the active material particle and the sulfide solid electrolyte. Thus, it is possible to restrain reaction and deterioration due to the contact of the active material particle and the sulfide solid electrolyte.

In the present invention, composite particles on the market may be used, or those properly prepared may be used. Examples of a way of preparing the composite particles include a preparation method utilizing spray coating as described in the above Patent Literature 1 (JP 2010-073539 A), a tumbling fluidized coating method, spraying, immersion and a method utilizing a spray dryer.

Further included may be a pretreatment step of mixing the composite particles and/or the crystalline sulfide solid electrolyte with a compound having an alkyl group, prior to the coating step. Carrying out such a pretreatment step makes it possible to attach compounds having an alkyl group to the surface of the composite particle and/or the surface of the sulfide solid electrolyte. The coverage of the sulfide solid electrolyte over the surface of the composite particle is comparatively gradually increased as processing time for coating is passing by carrying out such a pretreatment step. Thus, it becomes easy to stably produce composite active materials of the desired coverage, which is in the range from the relatively low coverage (for example, the coverage of 80 to 90% and the like) to the relatively high coverage.

It is considered that the reason why the coverage of the sulfide solid electrolyte is comparatively gradually increased as processing time for kneading by carrying out the pretreatment step is: the surface free energy is reduced by modification of the surfaces of the sulfide solid electrolyte and the composite particle by an alkyl group; as a result, it gets difficult to obtain the free energy gain derived from the contact of the surfaces of the composite particle and the sulfide solid electrolyte.

A compound having an alkyl group used in the pretreatment step is not especially limited as long as being an alkyl group containing compound that reduces the adherence of the composite particle and/or the sulfide solid electrolyte at the interfaces, that is, being an alkyl group containing compound that reduces the surface free energy on the material.

Examples of a compound having an alkyl group employable in the pretreatment step include an alkylamine such as trimethylamine ((CH₃)₃N), triethylamine ((C₂H₅)₃N), tripropylamine ((C₃H₇)₃N) and tributylamine ((C₄H₉)₃N); an ether compound such as ethylether ((C₂H₅)₂O), propylether ((C₃H₇)₂O) and butylether ((C₄H₉)₂O); a nitrile compound such as butylnitrile (C₄H₉CN), pentylnitrile (CH₅H₁₁CN) and isopropylnitrile (i-C₃H₇CN); an ester compound such as butylacetate (C₂H₉CO₂C₂H₅), butylbutyrate (C₄H₉CO₂C₄H₉) and ethylbutyrate (C₄H₉CO₂C₂H₅); and an aromatic compound such as benzene (C₆H₆), xylene (C₅H₁₀) and toluene (C₇H₅). It is preferable to employ alkylamine among these compounds.

It is more preferable that the mixing method in the pretreatment step is wet mixing using a dispersion medium in view of uniformly attaching compound having an alkyl group to the surface of the composite particle and/or the surface of the sulfide solid electrolyte. Examples of a dispersion medium employable in wet mixing include alkanes such as n-hexane (C₆H₄), n-heptane (C₇H₁₆) and n-octane (C₈H₁); ether compounds such as ethylether ((C₂H₃)₂O), propylether ((C₃H₇)₂O) and butylether ((C₄H₉)₂O); nitrile compounds such as butylnitrile (C₄H₉CN), pentylnitrile (C₅H₁₁CN) and isopropylnitrile (i-C₃H₇CN); ester compounds such as butylacetate (C₂H₅CO₂C₄H₉), butylbutyrate (C₄H₉CO₂C₄H₉) and ethylbutyrate (C₄H₉CO₂C₂H₅); and aromatic compounds such as benzene (C₆H₆), xylene (C₈H₁₀) and toluene (C₇H₈). One kind of these dispersion media may be solely employed. Alternatively, two or more kinds thereof may be combined to be employed.

In a case where wet mixing is carried out, a mixture after the wet mixing may be suitably heated to remove the dispersion medium and dried.

An example of the pretreatment step will be explained hereinafter. First, the composite particles, the sulfide solid electrolyte, compounds having an alkyl group and properly, a dispersion medium are mixed together. In this time, the mixture may be irradiated with ultrasonic waves to highly disperse these materials over the dispersion medium. Next, the obtained mixture is heated for 1 to 5 hours under the temperature conditions of 80 to 120° C., to be dried. The dried mixture is used for the following coating step.

(1-2. Coating Step)

This step is the coating step of mixing the composite particles and a crystalline sulfide solid electrolyte while controlling a temperature of a mixture of the composite particles and the sulfide solid electrolyte to be no greater than 58.6° C. and while applying an energy to the mixture such that the sulfide solid electrolyte undergoes plastic deformation, such that the surfaces of the composite particles are coated with the sulfide solid electrolyte.

The sulfide solid electrolyte is not especially limited as long as containing sulfur (S) and having a chemical affinity for the composite particle (especially, the oxide solid electrolyte) so as to be possible to coat the surface of the composite particle described above. Exemplifications of the sulfide solid electrolyte include Li₂S—SiS₂, Li₂S—P₂S₅, Li₂S—GeS₂ and Li₂S—B₂S₃ sulfide solid electrolytes. More specifically, exemplifications thereof include Li₂S—P₂S₅, Li₂S—P₂S₃, Li₂S—P₂S₃—P₂S₅, Li₂S—SiS₂, LiI—Li₂S—P₂S₅, LiI—Li₂S—SiS₂—P₂S₅, LiI—Li₂S—P₂S₅—Li₂O, Li₂S—SiS₂—Li₄SiO₄, Li₂S—SiS₂—Li₃PO₄, Li₂S—GeS₂, Li₃PS₄—Li₄GeS₄, Li_{3.25}Ge_{0.25}P_{0.75}S₄, Li₂S—B₂S₃, Li_{3.4}P_{0.6}Si_{0.4}S₄, Li₄₋ₓGe₁₋ₓPₓS₄ and Li₇P₃S₁₁ sulfide solid electrolytes. Especially, a sulfide solid electrolyte including Li₂S—P₂S₅ in its composition is preferable among these sulfide solid electrolytes. A sulfide solid electrolyte including LiI—Li₂S—P₂S₅—Li₂O in its composition is more preferable.

It can be confirmed that the sulfide solid electrolyte is a crystalline electrolyte if the peak is perceived through the measurement of X-ray diffraction (XRD).

It is preferable that the sulfide solid electrolyte used in this step is sulfide solid electrolyte particles having the average particle size of no greater than 1 μm. The smaller the average particle size of the sulfide solid electrolyte is used, the more the coverage of the sulfide solid electrolyte can be improved. As a result, the power of a lithium battery that uses this composite active material can be improved. It is considered the reason is that the smaller the average particle size of the sulfide solid electrolyte particles is, the easier the surface of the composite particle is filled with the sulfide solid electrolyte particles without any gap.

It is preferable that the average particle size of the sulfide solid electrolyte particles used in the present invention is no greater than 0.9 μm, and more preferably no greater than 0.8 μm. It is also preferable that the average particle size is no less than 0.01 μm.

The way of measuring the average particle size is as described above.

It is preferable that the loading of the sulfide solid electrolyte to the composite particle is loading so that the ratio of (average particle size of the composite particle):(average thickness of the sulfide solid electrolyte layer) is within the range from 30:1 to 95:1, and more preferably, from 38:1 to 63:1. If the sulfide solid electrolyte layer is too thick compared to the average particle size of the composite particles: a conductive assistant that is an electrode material and the active material particles become difficult to touch each other in a case where the composite active materials are contained in, for example, an electrode of a battery, electron conduction paths are cut, and as a result, the power of the battery might reduce. On the other hand, if the sulfide solid electrolyte layer is too thin compared to the average particle size of the composite particles, ion paths such as lithium ion paths are cut, and the power of the battery might reduce. As to the specific loading of the sulfide solid electrolyte, it is preferable that the sulfide solid electrolyte of 5 to 25 parts by mass, more preferably, 8 to 22 parts by mass, is loaded to the composite particles of 100 parts by mass.

In this step, the composite particles and the sulfide solid electrolyte are mixed together while energy is applied so that the sulfide solid electrolyte undergoes plastic deformation.

Plastic deformation of the sulfide solid electrolyte means that the sulfide solid electrolyte cannot keep its original shape in the early coating step, to deform irreversibly. In this time, chemical bonds between atoms composing the sulfide solid electrolyte do not cut off, or the composition of the sulfide solid electrolyte does not change. Especially, in a case where particles of the sulfide solid electrolyte are used as the material, plastic deformation in the present invention means that as a result of the sulfide solid electrolyte particles losing their shapes, adjacent sulfide solid electrolyte particles are mixed with each other, and at least a part of grain boundaries between the particles disappears.

The particles of the sulfide solid electrolyte are attached to the surfaces of the composite particles, to undergo plastic deformation from particles to films, by mixing the composite particles and the crystalline sulfide solid electrolyte together while energy is applied so that the sulfide solid electrolyte undergoes plastic deformation. As a result, the surfaces of the composite particles are coated with the sulfide solid electrolyte.

Examples of energy through which the sulfide solid electrolyte undergoes plastic deformation include energy applied to the sulfide solid electrolyte so that the sulfide solid electrolyte yields, fracture energy applied to the sulfide solid electrolyte until the energy fractures the sulfide solid electrolyte, and (physical) strain energy stored in the sulfide solid electrolyte until the shape of the sulfide solid electrolyte become strained.

Energy through which the sulfide solid electrolyte undergoes plastic deformation will be further described hereinafter in view of yielding. Examples of energy through which the sulfide solid electrolyte undergoes plastic deformation include energy that causes the sulfide solid electrolyte to reach the upper yield point, which shows the maximum stress in yielding, when a so-called stress-strain diagram is plotted as to the sulfide solid electrolyte; in the diagram, the vertical axis shows stress σ (N/mm²) and the horizontal axis shows strain (%). Exemplifications of energy through which the sulfide solid electrolyte undergo plastic deformation in a stress-strain diagram where an upper yield point is not clearly perceived include energy applying yield strength to the sulfide solid electrolyte (that is, stress when plastic strain that remains after loads are removed is 0.2%).

The stress-strain diagram of the sulfide solid electrolyte is obtained using a method conforming to JISK7181, especially by plotting at least “10.1 Compressive Stress” and “10.2 Compressive Strain” measured by “9 Procedure” of this standard using “5 Apparatus” and “6 Test Specimen” of this standard.

In mixing in the coating step, it is preferable that shearing force is applied to the mixture of the composite particles and the sulfide solid electrolyte so as to give energy through which plastic deformation is undergone as described above. Exemplifications of the way of applying shearing force so as to give energy through which plastic deformation is undergone preferably include a mechanical kneading of giving friction and shearing energy, preferably, dry mechanical kneading of giving friction and shearing energy, to the mixture between a rotor that is provided in a mixing vessel and is mechanically driven, and an inner wall of the mixing vessel. Exemplifications of an apparatus that makes it possible to achieve such mechanical kneading include mechanically kneading apparatuses without using any media. Among them, a dry kneading apparatus is preferably exemplified. As such a mechanically kneading apparatus, common mechanically kneading apparatuses commercially available can be used without any limitation: for example, Nobilta (brand name: manufactured by Hosokawa Micron Corporation), Mechanofusion, Hybridization and COMPOSI (brand name: manufactured by Nippon Coke & Engineering Co. Ltd.). Employment of a mechanically kneading apparatus without using any media makes it possible to reduce thermal and mechanical damages against the active material particles compared with the case where a kneading apparatus using a medium such as a planetary ball mill is employed. Compared with a vapor phase process such as pulsed laser deposition (PLD), it is possible to improve productivity because the speed of coating is outstandingly rapid.

It can be achieved by, for example, making the circumferential speed of the rotor 13.8 m/s or over, preferably, 18.4 m/s or over that energy through which the sulfide solid electrolyte undergoes plastic deformation is applied by the mechanically kneading apparatus, which gives friction and shearing energy to the mixture between the rotor that is provided in the mixing vessel and is mechanically driven, and the inner wall of the mixing vessel. Here, “circumferential speed” of the rotor means the speed of the movement of the rotating rotor at the point which is furthest away from the rotation axis. The circumferential speed of the rotor is determined by the diameter of the rotor and the rotation rate (rotation/min., rpm). Thus, if the diameter of the rotor is given, the rotation rate of the rotor necessary for applying energy through which the sulfide solid electrolyte undergoes plastic deformation is determined. Generally, mechanically kneading apparatuses without using any media, especially dry kneading apparatuses are used for the purpose of mixing relatively hard materials together. Since the sulfide solid electrolyte is a relatively soft material, the above minimum values of the circumferential speed of the rotor are values enough for common sulfide solid electrolytes to undergo plastic deformation.

In a case where the coating step is carried out using the mechanically kneading apparatus, which gives friction and shearing energy to the mixture between the rotor that is provided in the mixing vessel and is mechanically driven, and the inner wall of the mixing vessel, the narrower the space between the tip of the rotor and the inner wall of the mixing vessel is, the more the shearing force that is applied to the mixture increases and the more the progress of the coating process of the composite particles with the sulfide solid electrolyte speeds up. It is considered however that the active material particles are easy to be fractured and the like because mechanical force applied to the mixture gets strong. On the other hand, the wider the space between the tip of the rotor and the inner wall of the mixing vessel is, the less the shearing force that is applied to the mixture is and the longer time it takes for the coating process of the composite particles with the sulfide solid electrolyte. However, it is expected that the temperature increase in the mixture is reduced. The space between the tip of the rotor and the inner wall of the mixing vessel can be suitably selected in view of these circumstances.

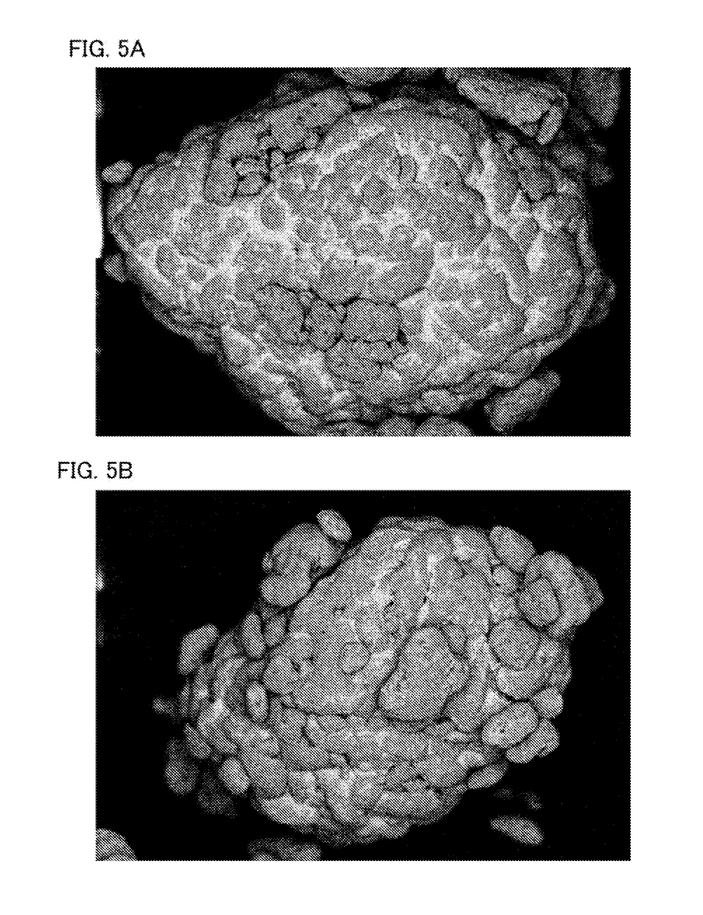

Whether the sulfide solid electrolyte undergoes plastic deformation can also be determined by an SEM image of the composite active material particles. The shape of the sulfide solid electrolyte (dark contrast) attached to the surface of the cathode active material (light contrast) can be perceived by observing a reflection electron image of the surface of a material particle coated with the sulfide solid electrolyte through SEM. FIG. 5A depicts an example of an SEM image (reflection electron image) on which it can be perceived that the sulfide solid electrolyte is attached to the surface of the composite particle as is the form of particles. FIG. SB depicts an example of an SEM image (reflection electron image) on which it can be perceived that the sulfide solid electrolyte undergoes plastic deformation on the surface of a composite particle from the form of particles to the form of films. On the SEM image of FIG. 5B, unlike the SEM image of FIG. 5A, as a result of the sulfide solid electrolyte undergoing plastic deformation on the surface of the composite particle to films, the borders between the active material (light contrast) and the sulfide solid electrolyte (dark contrast) becomes unclear.

In the coating step, the composite particles and the crystalline sulfide solid electrolyte are mixed together while the temperature of the mixture is controlled to be no greater than 58.6° C. If mixing is carried out while friction and shearing energy are applied to the mixture as described above, heat is generated. Thus, the temperature of the mixture rises. If the temperature of the mixture is beyond 58.6° C., the crystallinity of the sulfide solid electrolyte gets worse due to the heat. Then, the ion conductivity of the sulfide solid electrolyte becomes low, and as a result, the performance of a battery employing the composite active material might get worse. Thermal damages against the crystalline sulfide solid electrolyte, that is, change in the composition and deterioration of the crystallinity due to heat are restrained by carrying out mixing in the coating step while controlling the temperature of the mixture to be no greater than 58.6° C., and the sulfide solid electrolyte coating of good ion conductivity can be formed on the surface of the composite particle.

It is preferable that the temperature of the mixture in the coating step is kept no greater than 58.6° C., more preferably, no greater than 40° C.

The temperature of the mixture can be measured by, for example, installation of a thermocouple on the inner wall of the mixing vessel.

It is preferable in order to keep the temperature of the mixture in the coating step no greater than the above described maximum values, to carry out mixing while cooling the mixture and a part where the kneading apparatus touches the mixture, using cooling means. Examples of cooling means usable in the present invention include cooling the processing vessel, using fluid. Above all, preferably employed can be cooling the processing vessel, using liquid that is cooled to be a very low temperature as a coolant.

In the coating step, in view of keeping the temperature of the mixture no greater than the above described maximum values, it is preferable that mixing the composite particles and the sulfide solid electrolyte together includes:

(i) the first mixing step of carrying out the mixing under the condition such that the sulfide solid electrolyte undergoes plastic deformation; and

(ii) the second mixing step of carrying out the mixing under the condition such that the sulfide solid electrolyte does not undergo plastic deformation; and the first mixing step and the second mixing step are alternately carried out. When the sulfide solid electrolyte undergoes plastic deformation, much heat tends to be generated, to rapidly raise the temperature of the mixture. On the other hand, when the sulfide solid electrolyte does not undergo plastic deformation, the generation of heat is relatively a little. Therefore, the temperature of the mixture that rapidly rises during the first mixing step (i) can be lowered during the second mixing step (ii) by alternately repeating (i) mixing under the condition where the sulfide solid electrolyte undergoes plastic deformation (first mixing step) and (ii) mixing under the condition where the sulfide solid electrolyte does not undergo plastic deformation (second mixing step), and therefore, it gets easy to keep the temperature of the mixture no greater than the above described maximum values.

A condition where the above described sulfide solid electrolyte undergoes plastic deformation can be employed as the condition of mixing in (i) the first mixing step.

The condition of mixing in (ii) the second mixing step can be achieved by, for example, making the circumferential speed of the rotor that rotates and is provided in the mixing vessel, which a mechanically kneading apparatus has, no more than 13.8 m/s in the case of mixing by the mechanically kneading apparatus.

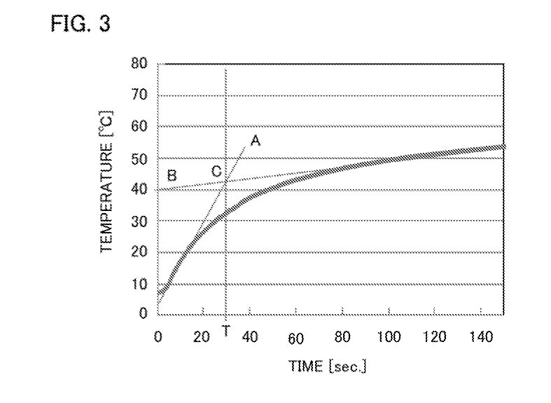

Time for carrying out the first mixing step once and time for carrying out the second mixing step once can be determined suitably in view of the change in the temperature of the mixture as time passes and the productivity concerning each step. For example, the maximum time for carrying out the first mixing step once (time for continuously carrying out the first mixing step at once) can be determined by the following: FIG. 3 depicts an example of a graph that is a plot of the temperature increase of the mixture against the operation time of the first mixing step in a case where only the first mixing step is continuously carried out as the coating step. In the graph of FIG. 3, calculated can be operation time (T) corresponding to the intersection (point C) of the extension line of the most rapid temperature increase right after the beginning of the coating step (line AC) and the tangential line which touches the curve at an operation time when the temperature increase per unit time converges (line BC). This time T can be expressed to be operation time when the material temperature (temperature over the inner wall surface of the mixing vessel) against the average temperature of the mixing vessel resulting from the cooling capacity of the apparatus is divided into high and low ranges. Time from the beginning of the operation to the time T corresponds to the range where the difference between the temperature of the mixture and the average temperature of the mixing vessel is small. Time after the time T corresponds to the range where the difference between the temperature of the mixture and the average temperature of the mixing vessel is large. The quantity of heat removed from the mixture is almost in proportion to the temperature gradient that is in the direction of the thickness of the wall of the mixing vessel concerning the inner wall surface of the vessel. Thus, in a case where operation is carried out with high load so that the difference between the temperature of the mixture and the average temperature of the mixing vessel is large, the temperature of the mixture tends to rise suddenly if the first mixing step is continuously carried out at once. In a case where time during which the first mixing step is continuously carried out at once is no longer than the time T, the operation is carried out within the range where the difference between the temperature of the mixture (temperature over the inner wall surface of the mixing vessel) and the average temperature of the mixing vessel is small. Therefore, it is easy to keep the temperature of the mixture low.

The coating step is possible to take the following manner: adding the crystalline sulfide solid electrolyte to the mixture after mixing for 10 minutes or more; and thereafter carrying out the mixing while controlling the temperature of the mixture to be no greater than 58.6° C. and while applying an energy to the mixture such that the sulfide solid electrolyte undergoes plastic deformation. It becomes possible to obtain the composite active material of the extremely high coverage of the sulfide solid electrolyte over the composite particle by additionally mixing the sulfide solid electrolyte during the coating step. In this case, it is preferable to add the crystalline sulfide solid electrolyte to the mixture 1 to 10 times, and more preferably, 1 to 5 times.

(1-3. Composite Active Material)

The composite active material obtained by the producing method of the present invention will be explained. The composite active material of the present invention includes the composite particle that includes the active material particles and the oxide solid electrolyte coating at least a part of the surfaces of the active material particles, wherein the active material particles include lithium, oxygen and at least one selected from the group consisting of cobalt, nickel, and manganese, and also includes the sulfide solid electrolyte with which the surface of the composite particle is further coated.

It is preferable that as to the composite active material particle obtained by the producing method of the present invention, 76.0% or more of the surfaces of the composite particles is coated with the sulfide solid electrolyte, that is, the coverage of the sulfide solid electrolyte when the entire surface area of the composite particles is assumed as 100% (hereinafter may be referred to as the coverage of the sulfide solid electrolyte) is 76.0% or more. The coverage 76.0% or more of the sulfide solid electrolyte makes it possible to effectively increase the power of a battery in a case where the composite active material is employed in the battery.

It is preferable that the coverage of the sulfide solid electrolyte is no less than 85% and no more than 95%, more preferably, no less than 87% and no more than 93%. Since the coverage of the sulfide solid electrolyte is no more than the above described maximum values, the probability that a conductive assistant that is an electrode material touches the active material particles is more increased when the composite active material is, for example, contained in an electrode of a battery. Thus, it is expected that electron conduction paths are more surely secured. Therefore, it becomes possible to more effectively increase the power of the battery in a case where the composite active material is employed in the battery. In addition, since the coverage of the sulfide solid electrolyte is no less than the above described minimum values, ion conduction paths by the sulfide solid electrolyte are more surely formed when the composite active material is employed in the battery. As a result, it becomes possible to more effectively increase the power of the battery.

The coverage of the sulfide solid electrolyte can be calculated using known methods. Examples of methods for calculating the coverage of the sulfide solid electrolyte include a method of measuring the composite active material by XPS (X-ray photoelectron spectroscopy), calculating ER (Element Ratio) from the peak cross section of each element, and calculating the coverage from the element ratio (ER), using the formula (B) below.

The coverage of the sulfide solid electrolyte=ΣER_{S}/(ΣER_{A}+ΣER_{O}+ΣER_{S}) Formula (B)

(in the above formula (B), ΣER_{S} represents the sum total of the element ratio of each element that composes the sulfide solid electrolyte and that can be measured by XPS; ΣER_{A} represents the total sum of the element ratio of each element that composes the active material particle and that can be measured by XPS; and ΣER_{O} represents the sum total of the element ratio of each element that composes the oxide solid electrolyte and that can be measured by XPS)

The coverage of the sulfide solid electrolyte in the present invention also can be perceived by SEM or the like qualitatively. For example, it is represented that the weaker the contrast is on a reflection electron image of the surface of the composite particle by SEM, the smaller the difference in element distribution on its surface is. Then, it is found that the surface of the composite particle is uniformly coated with the sulfide solid electrolyte with the high coverage. Specifically, in a case of the composite active material wherein the surface of the composite particle is coated, using the sulfide solid electrolyte particles, it is found that the less unevenness is on a secondary electron image of the surface of the composite particle by SEM, the more the grain boundaries of the sulfide solid electrolyte particles existing on the surface disappear and the surface of the composite particle is uniformly coated with the sulfide solid electrolyte.

Examples of conditions for measuring a reflection electron image and a secondary electron image by SEM include conditions of, acceleration voltage: 0.5 to 5 kV, emission current: 1 to 100 μA with SEM (manufactured by Hitachi High-Technologies Corporation, series number SU8030) or the like with a magnification of 1,000 to 50,000 times.

The average particle size of the composite active material produced by the producing method of the present invention can be, although it depends on the use of the composite active material, for example, 0.1 to 35 μm.

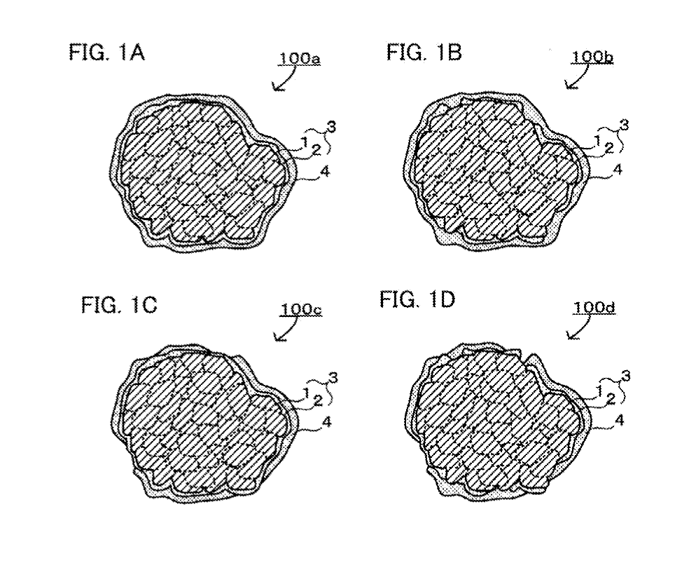

FIGS. 1A to 1D are schematic cross-sectional views depicting examples of embodiments of the composite active materials obtained by the producing method of the present invention. FIGS. 1A to 1D are just drawings for explaining manners of coating materials in some embodiments qualitatively, but not drawings that exactly reflect the actual coverage or particle sizes of solid electrolytes, the thicknesses of solid electrolyte layers and the like quantitatively.

As depicted in FIGS. 1A to 1D, each of composite active materials 100a to 100d includes a composite particle 3 that is composed by at least a part of the surface of an active material particle 1 coated with an oxide solid electrolyte 2, and a sulfide solid electrolyte 4 with which at least a part of the surface of the composite particle 3 is further coated. Dashed lines in FIGS. 1A to 1D depict grain boundaries of single crystalline particles in the polycrystalline active material particle 1, and solid lines therein that depict boundaries between the active material particle 1 and the layer of the oxide solid electrolyte 2 depict an outer edge of the polycrystalline active material particles, which are composed by bonding these single crystalline particles.

Among them. FIG. 1A is a schematic cross-sectional view of the composite active material 100a that includes the composite particle 3 that is composed by the entire surface of the active material particle 1 coated with the oxide solid electrolyte 2, and the sulfide solid electrolyte 4 with which the entire surface of the composite particle 3 is further coated. FIG. 1B is a schematic cross-sectional view of the composite active material 100b that includes the composite particle 3 that is composed by a part of the surface of the active material particle 1 coated with the oxide solid electrolyte 2, and the sulfide solid electrolyte 4 with which the entire surface of the composite particle 3 is further coated. The coverage of the sulfide solid electrolyte over the composite active materials 100a and 100b is 100%.

On the other hand, FIG. 1C is a schematic cross-sectional view of the composite active material 100c that includes the composite particle 3 that is composed by the entire surface of the active material particle 1 coated with the oxide solid electrolyte 2, and the sulfide solid electrolyte 4 with which a part of the surface of the composite particle 3 is further coated. FIG. 1D is a schematic cross-sectional view of the composite active material 100d that includes the composite particle 3 that is composed by a part of the surface of the active material particle 1 coated with the oxide solid electrolyte 2, and the sulfide solid electrolyte 4 with which a part of the surface of the composite particle 3 is further coated. The coverage of the sulfide solid electrolyte over the composite active materials 100c and 100d is preferably 76.0% or over.

By the producing method of the present invention, all of the above composite active materials 100a to 100d can be produced. In a case where the composite active materials of certain quantities are mass-produced by the producing method of the present invention, the same lots may consist of one kind of the composite active materials 100a to 100d, or may consist of the mixture of two or more kinds of the composite active materials 100a to 100d.

<2. Lithium Battery>

The lithium battery of the present invention is a lithium battery including a cathode; an anode; and an electrolyte layer arranged between the cathode and the anode, wherein the cathode and/or the anode comprises the composite active material produced by the above producing method.

It is possible to improve the power of the lithium battery of the present invention by the lithium battery including the composite active material produced by the producing method of the present invention.

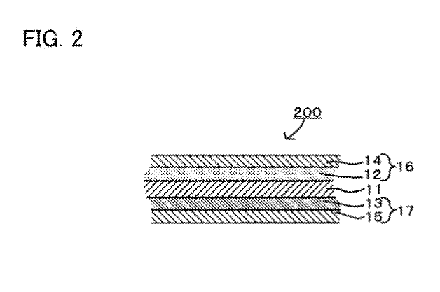

FIG. 2 is a view depicting an example of a layered structure of the lithium battery of the present invention, which schematically depicts the cross section cut in the layering direction. The lithium battery according to the present invention is not always limited to only this example.

A lithium battery 200 includes a cathode 16 that has a cathode active material layer 12 and cathode current collector 14, an anode 17 that has an anode active material layer 13 and an anode current collector 15, and an electrolyte layer 11 that is clamped by the cathode 16 and the anode 17.

Hereinafter, explained in detail will be the cathode, anode and electrolyte layer employed for the lithium battery according to the present invention, and a separator and battery case preferably employed for the lithium battery according to the present invention.

The cathode preferably has the cathode active material layer containing the above described composite active material. In addition, the cathode usually has a cathode current collector and a cathode lead that is connected to the cathode current collector.

As the cathode active material, the composite active material obtained by the above described producing method of the present invention may be solely employed; or the combination of the composite active material and one or two or more kinds of other cathode active materials may be employed. Examples of other cathode active materials include layered cathode active materials such as LiCoO₂, LiNiO₂, LiNi_{1/3}Mn_{1/3}Co_{1/3}O₂, LiVO₂ and LiCrO₂; spinel type cathode active materials such as LiMn₂O₄, Li₂NiMn₃O₈ and LiCoMnO₄; olivine type cathode active materials such as LiCoPO₄, LiMnPO₄, LiFePO₄ and LiNiPO₄; and NASICON type cathode active materials such as Li₃Fe₂(PO₄)₃ and Li₃V₂(PO₄)₃. The surfaces of minute particles composed of the cathode active material may be coated with LiNbO₃ or the like.

The percentage of the total content of the cathode active material in the cathode active material layer is usually within the range from 50 to 90% by mass.

The thickness of the cathode active material layer employed in the present invention is different depending on the use and so on of the lithium battery to be aimed. Preferably, the thickness thereof is from 10 to 250 μm, more preferably, from 20 to 200 μm, and especially preferably, from 30 to 150 μm.

The cathode active material layer may contain a conductive material, a binder and so on if necessary.

The electronic conductivity of the cathode active material layer can be improved by the cathode active material layer containing a conductive material. A conductive material is not especially limited as long as it is possible to improve the conductivity of the cathode active material layer. Examples of a conductive material include carbon black such as acetylene black and ketjen black, carbon fiber, and so on. The percentage of the content of a conductive material in the cathode active material layer varies depending on the kind of a conductive material. Usually, the percentage of the content thereof is within the range from 1 to 30% by mass.

Examples of a binder include an acrylic binder, a binder containing fluorine such as polyvinylidenefluoride (PVdF) and polytetrafluoroethylene (PTFE); and a rubber binder such as butadiene rubber. A rubber binder is not especially limited; however, preferably employed can be hydrogenated butadiene rubber and hydrogenated butadiene rubber composed by a functional group introduced to the end thereof. The content of a binder in the cathode active material layer may be the content so as to fix the cathode active material and so on. The less the content thereof is, the more preferable. The percentage of the content of a binder is usually within the range from 1 to 10% by mass.

For preparation of the cathode active material, used may be a dispersion medium such as N-methyl-2-pyrrolidone, acetone, butylbutyrate, dibutylether and heptane.

A cathode current collector employed in the present invention has a function of collecting current of the above cathode active material layer. Examples of materials of the above cathode current collector include aluminum, SUS, nickel, iron and titanium. Among all, aluminum and SUS are preferable. Examples of shapes of the cathode current collector include foil, a board and a mesh. Among them, foil is preferable.

A method for producing the cathode employed in the present invention is not especially limited as long as the above cathode can be obtained via this method. The cathode active material layer may be pressed after being formed in order to improve the density of the electrode.

The anode employed in the present invention preferably has the anode active material layer containing the above described composite active material. In addition, the anode usually has an anode current collector and an anode lead that is connected to the anode current collector.

As the anode active material, the composite active material obtained by the above described producing method of the present invention may be solely employed or the combination of the composite active material and one or two or more kinds of other anode active materials may be employed.

Other anode active materials are not especially limited as long as they can occlude and/or emit lithium ions. Examples thereof include a carbon active material, an oxide active material, a metallic active material, metallic sulfides containing lithium and metallic nitrides containing lithium. A carbon active material is not especially limited as long as it contains carbon. Examples of a carbon active material include mesocarbon microbeads (MCMB), graphite, high oriented graphite (HOPG), hard carbon and soft carbon. Examples of an oxide active material include Nb₂O₅, SiOₓ, and metallic oxides containing lithium (for example, Li₄Ti₅O₂). Examples of a metallic active material include lithium metal, lithium alloy (for example, Li—Al alloy, Li—Sn alloy, Li—Pb lead alloy and Li—Si alloy), In, Al, Si and Sn. Examples of metallic nitrides containing lithium include lithium cobalt nitrides, lithium iron nitrides and lithium manganese nitrides.

The anode active material may be like either powders, or a membrane. Lithium metal that is coated with a solid electrolyte can be employed as the anode active material.

The anode active material layer may contain either only the anode active material, or at least one of a conductive material and a binder in addition to the anode active material. For example, in a case where the anode active material has the form of foil, the anode active material layer may contain only the anode active material. On the other hand, in a case where the anode active material has the form of powders, the anode active material layer may contain the anode active material and a binder. A conductive material and a binder here are the same as the above described conductive material and the binder, which may be contained in the cathode active material layer.

The thickness of the anode active material layer as a film is not especially limited. For example, the thickness can be preferably from 10 to 100 μm, and more preferably, from 10 to 50 μm or the like.

An electrode active material layer of at least one of the cathode and anode can contain an electrode active material and an electrolyte for electrodes. In this case, as an electrolyte for electrodes, employed can be a solid electrolyte such as a solid oxide electrolyte and a solid sulfide electrolyte, and a gel electrolyte as described below.

A material same as that of the cathode current collector described above can be employed for the anode current collector. A shape same as that of the cathode current collector described above can be employed for the anode current collector.

A method for producing the anode employed in the present invention is not especially limited as long as the above anode can be obtained via this method. The anode active material layer may be pressed after being formed in order to improve the density of the electrode.

The electrolyte layer is held between the cathode and the anode, and has a function of exchanging lithium ions between the cathode and the anode.

For the electrolyte layer, an electrolytic solution, a gel electrolyte, a solid electrolyte and the like can be employed. Only one kind of them may be solely used. Or, the combination of two or more kinds of them may be used.

As an electrolytic solution, a non-aqueous electrolytic solution and an aqueous electrolytic solution can be employed.

Generally, a non-aqueous electrolytic solution containing lithium salts and a non-aqueous solvent is used. Examples of the lithium salts include inorganic lithium salts such as LiPF₆, LiBF₄, LiClO₄ and LiAsF₆; and organic lithium salts such as LiCF₃SO₃, LiN(SO₂CF₃)₂(Li-TFSA), LiN(SO₂C₂F₅)₂ and LiC(SO₂CF₃)₃. Examples of the non-aqueous solvent include ethylene carbonate (EC), propylene carbonate (PC), dimethyl carbonate (DMC), diethyl carbonate (DEC), ethylmethyl carbonate (EMC), ethyl carbonate, butylene carbonate, γ-butyrolactone, sulfolane, acetonitrile (AcN), dimethoxymethane, 1,2-dimethoxyethane (DME), 1,3-dimethoxypropane, diethylether, tetraethyleneglycoldimethylether (TEGDME), tetrahydrofuran, 2-methyltetrahydrofuran, dimethylsulfoxide (DMSO) and the mixture thereof. The concentration of the lithium salts in the non-aqueous electrolytic solution is, for example, from 0.5 to 3 mol/kg.

For example, an ionic liquid or the like may be used as the aqueous electrolytic solution or non-aqueous solvent. Examples of an ionic liquid include N-methyl-N-propylpiperidinium bis(trifluoromethanesulfonyl)amides (PP13TFSA), N-methyl-N-propylpyrrolidinium bis(trifluoromethanesulfonyl)amides (P13TFSA), N-butyl-N-methylpyrrolidinium bis(trifluoromethanesulfonyl)amides (P14TFSA), N,N-diethyl-N-methyl-N-(2-methoxyethyl)ammonium bis(trifluoromethanesulfonyl)amides (DEMETFSA) and N,N,N-trimethyl-N-propylammonium bis(trifluoromethanesulfonyl)amides (TMPATFSA).

Generally, an aqueous electrolytic solution containing lithium salts and water is used. Examples of the lithium salts include lithium salts such as LiOH, LiCl, LiNO₃ and CH₃CO₂Li.

A gel electrolyte is generally a gelatinized non-aqueous electric solution where polymers are added. For example, a non-aqueous gel electrolyte can be obtained by adding polymers such as polyethylene oxide (PEO), polyacrylonitrile (PAN), polymethylmethacrylate (PMMA), polyurethane, polyacrylate and/or cellulose to the above non-aqueous electrolytic solution, to be gelatinized. In the present invention, a LiTFSA (LiN(CF₃SO₂)₂)-PEO non-aqueous gel electrolyte is preferable.

As the solid electrolyte, an oxide solid electrolyte, a sulfide solid electrolyte, a polymer electrolyte and the like can be used. Among them, concrete examples of an oxide solid electrolyte and a sulfide solid electrolyte are the same as described above. It is noted that a crystalline sulfide solid electrolyte is not necessarily used; an amorphous sulfide solid electrolyte may be used.

A polymer electrolyte usually contains lithium salts and polymers. The inorganic and/or organic lithium salts described above can be used as lithium salts here. Polymers are not especially limited as long as forming lithium salts and complexes. Examples of a polymer include a polyethylene oxide and the like.

The lithium battery of the present invention may be provided with a separator impregnated with an electrolytic solution, between the cathode and the anode. Examples of this separator include a porous membrane of polyethylene, polypropylene and the like; and nonwoven fabric such as resin nonwoven fabric and glass fiber nonwoven fabric.

The lithium battery of the present invention usually includes a battery case that houses the above cathode, anode, the electrolyte layer, etc. Specifically, the shape of the battery case can be a coin, a flat plate, a cylinder, a laminate and so on.

### EXAMPLES

The present invention will be more specifically explained with examples hereinafter. The present invention is not limited to these examples.

### Examples 1 to 3 and Comparative Examples 1 to 2

### Example 1

Example 1 is an example of producing the composite active material by the method for producing the composite active material of the present invention.

Prepared were composite particles that were LiNi_{1/3}Co_{1/3}Mn_{1/3}O₂ particles (active material particles) coated with LiNbO₃ (oxide solid electrolyte) (Preparation step). The average particle size of the composite particles was 6.0 μm.

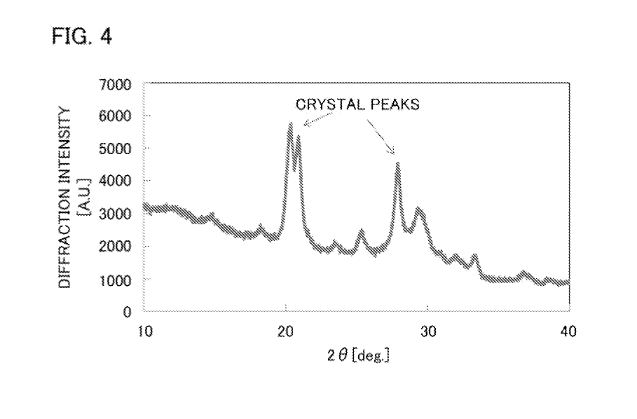

At a room temperature, 20 g of the composite particles and 4 g of crystalline 60Li₂S-20P₂S₅-20LiI particles (sulfide solid electrolyte, the average particle size: 0.8 μm, XRD: see FIG. 4) were put into a dry kneading apparatus (manufactured by Hosokawa Micron Corporation, brand name: NOB-MINI, the inside diameter of the mixing vessel: 90 mm); kneading (coating step) was carried out for 10 minutes under the conditions where the circumferential speed of the rotor was 27.6 m/s (rotation rate was (000 rpm) and the distance between the tip of the rotor and the inner wall of the mixing vessel was 1 mm, to produce the composite active material. During the kneading, a coolant was circulated through a jacket structure of a casing of the dry kneading apparatus by a chiller, to carry out cooling. A setting temperature of the cooling by the chiller was 5° C. The obtained composite active material was referred to as “composite active material of Example 1.”

### Example 2

A composite active material was produced as same as Example 1 except that the setting temperature of the cooling by the chiller was −50° C. The obtained composite active material was referred to as “composite active material of Example 2.”

### Example 3

A composite active material was produced as same as Example 2 except that the coating step was such that 20 sets of processes were carried out: each of the processes includes operation for 0.5 minutes under the first mixing condition (the circumferential speed of the rotor was 27.6 m/s) and operation for 1.5 minutes under the second mixing condition (the circumferential speed of the rotor was 2.3 ms). The obtained composite active material was referred to as “composite active material of Example 3.”

### Comparative Example 1

This is a comparative example without the coating step.

Dry blending was carried out on 20 g of the composite particles that were same as those of Example 1 and 4 g of crystalline 60Li₂S-20P₂S₅-20LiI particles that were same as those of Example 1 using a spatula at a room temperature. No cooling was carried out. The obtained composite mixture was referred to as “composite active material of Comparative Example 1.”

### Comparative Example 2

This is a comparative example where the temperature of the mixture in the coating step was beyond the range of the present invention.

The composite active material was produced as same as Example 1 except that the setting temperature of the cooling by the chiller was 20° C. The obtained composite active material was referred to as “composite active material of Comparative Example 2.”

(Evaluation)

Lithium batteries were produced using the composite active materials of Examples 1 to 3 and Comparative Examples 1 to 2, and the power of the batteries were measured.

Prepared for each example were the above composite active material as the cathode active material, the sulfide solid electrolyte same as the above (60Li₂S-20P₂S₅-20LiI particles) as the sulfide solid electrolyte, vapor grown carbon fiber (VGCF) as a conductive material, and PVdF as a binder. These cathode active material, sulfide solid electrolyte, conductive material and binder were mixed so as to have the ratio of the cathode active material:the sulfide solid electrolyte:the conductive material:the binder=81.3 parts by weight:16.6 parts by weight:1.2 parts by weight:0.8 parts by weight, to prepare a cathode mix.

For a material of a separator layer (solid electrolyte layer), the sulfide solid electrolyte same as the above (60Li₂S-20P₂S₅-20LiI particles) was prepared.

Prepared for each example were natural graphite as the anode active material, the sulfide solid electrolyte same as the above (60Li₂S-20P₂S₅-20LiI particles) as the sulfide solid electrolyte, and PVdF as a binder. These anode active material, sulfide solid electrolyte and binder were mixed so as to have the ratio of the anode active material:the sulfide solid electrolyte:the binder=54.8 parts by weight:43.4 parts by weight:1.8 parts by weight, to prepare a anode mix.

First, a green compact of 60Li₂S-20P₂S₅-20LiI particles that were a material of a solid electrolyte layer was prepared. Next, the cathode mix was arranged over one face of the green compact and the anode mix was arranged over the other face thereof, and planar press was carried out on them with pressure of 6 ton/cm² for pressure time of one minute, to obtain a layered body. Concerning the layered body obtained in this time, the thickness of the cathode mix layer was 30 μm, the thickness of the anode mix layer was 45 μm and the thickness of the separator layer was 300 μm. The layered body was constrained with pressure of 0.2 N in the layering direction, to produce a lithium battery.

Hereinafter, the lithium batteries that employed the composite active materials of Examples 1 to 3 and Comparative Examples 1 to 2 are referred to as the lithium batteries of Examples 1 to 3 and Comparative Examples 1 to 2, respectively.

The power of the batteries was measured by constant power discharge tests for five seconds each. The measurement was started when open circuit voltage (OCV) was 3.52 V. The batteries were discharged so that the power density was 20 mW/cm², 30 mW/cm², 40 mW/cm² and 50 mW/cm², and then time when electromotive force was reduced to 2.5 V was measured, and the maximum power dischargeable for five seconds was referred to as the power of the batteries. The results are shown in Table 1.

In Table 1, vessel temperature is a value of a measured temperature of the outer wall of the mixing vessel (outer surface of device wall). Mixture temperature is a value of temperature measured with a thermocouple installed onto the inner wall of the mixing vessel (inner surface of device wall).

TABLE 1

| | | Cooling Chiller | Vessel Temperature | Mixture Temperature | Power of |
|---|---|---|---|---|---|
| | | Setting Temperature | when Kneading was | when Kneading was | Battery |
| | Kneading in Coating Step | (° C.) | Completed (° C.) | Completed (° C.) | (kW/cm²) |
| Example 1 | Continuous Operation for 10 min. at | 5 | 58.6 | 58.6 | 44.4 |
| | 27.6 m/s of Circumferential Speed of | | | | |
| Example 2 | Continuous Operation for 10 min. at | −50 | 54.2 | 54.2 | 45.2 |
| | 27.6 m/s of Circumferential Speed of | | | | |
| Example 3 | (i) Operation for 0.5 min. at 27.6 m/s of | −50 | 30.5 | 40.0 | 46.5 |
| | Circumferential Speed of Rotor | | | | |
| | (ii) Operation for 1.5 min. at 2.3 m/s of | | | | |
| | Circumferential Speed of Rotor × | | | | |
| | 20 Sets | | | | |
| Comparative | Mixing Manually with Spatula | — | — | — | 42.4 |
| Example 1 | | | | | |
| Comparative | Continuous Operation for 10 min. at | 20 | 124.2 | 124.2 | 43.1 |
| Example 2 | 27.6 m/s of Circumferential Speed of | | | | |

(Evaluation Results)

The batteries employing the composite active materials of Examples 1 to 3 showed the improved power more than the battery of Comparative Example 1, on which the coating step was not carried out, and the battery of Comparative Example 2, in which the temperature of the mixture in the coating step was beyond the range of the present invention.

Compared with Example 1, the battery of Example 2, in which the temperature of the mixture in the coating step was kept lower than that of Example 1, showed the power more than the battery of Example 1.

The battery of Example 3, in which the temperature of the mixture during the kneading was kept much lower than that of Example 2 by including the first mixing step of mixing under the condition where the sulfide solid electrolyte underwent plastic deformation, and the second mixing step of mixing under the condition where the sulfide solid electrolyte did not undergo plastic deformation, into the mixing in the coating step, and the first and the second mixing step were repeated, showed the power more than the battery of Example 2 although the total time when the mixing was carried out under the condition where the sulfide solid electrolyte underwent plastic deformation was equal to that of Example 2.

It is considered that suppression of deterioration of the crystalline sulfide solid electrolyte due to heat by keeping the temperature of the mixture low in the coating step brought the improvement of the power of the batteries.

### Examples 4 to 6 and Comparative Example 3

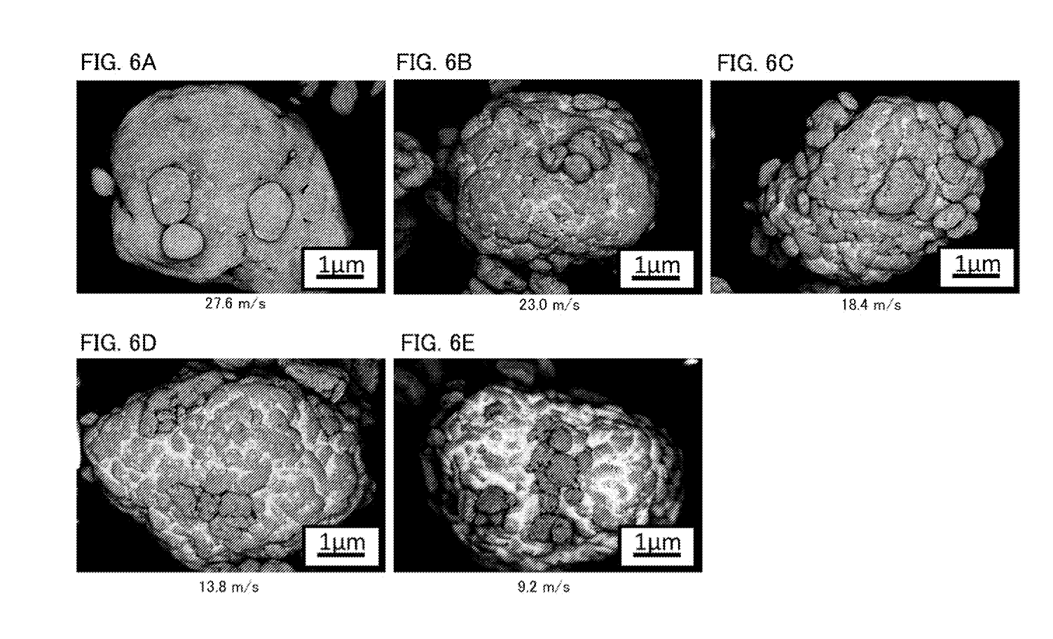

The composite active material was tried to be produced as well as Example 1 except that the circumferential speed of the rotor in producing the composite active material of Example 1 was changed from 27.6 m/s (rotation rate 6000 rpm) of Example 1 to 23 m/s (rotation rate 5000 rpm, Example 4), to 18.4 m/s (rotation rate 4000 rpm, Example 5), to 13.8 m/s (rotation rate 3000 rpm, Example 6) and 9.2 m/s (rotations rate 2000 rpm, Comparative Example 3). SEM observation (reflection electron image) was carried out on each of the composite active material particles, and it was determined whether the sulfide solid electrolyte underwent plastic deformation. The results are shown in Table 2 and FIGS. 6A to 6E. FIGS. 6A to 6E correspond to Examples 1, 4, 5 and 6 and Comparative Example 3, in order.

TABLE 2

| | Circumferential Speed | Shape of Sulfide | Plastic |
|---|---|---|---|
| | of Rotor (m/s) | Solid Electrolyte | Deformation |
| Example 1 | 27.6 | Film | Yes |
| Example 4 | 23.0 | Film | Yes |
| Example 5 | 18.4 | Film | Yes |
| Example 6 | 13.8 | Film | Yes |
| Comparative | 9.2 | Particle | No |
| Example 3 | | | |

Over the composite active materials of Examples 1 and 4 to 6, which were produced at 13.8 m/s or over of the circumferential speed of the rotor, as depicted in FIGS. 6A to 6D, the sulfide solid electrolyte particles underwent plastic deformation, to change like films. Thus, the distinction between the portions of the cathode active materials, which were light contrast, and the portions of the sulfide solid electrolytes, which were dark contrast, was unclear. On the other hand, over the composite active material of Comparative Example 3, which was produced at 9.2 m/s of the circumferential speed of the rotor, as depicted in FIG. 6E, the sulfide solid electrolyte did not undergo plastic deformation, and was attached to the surfaces of the composite particles as it kept its form particles. The distinction between the portion of the cathode active material, which was light contrast, and the portion of the sulfide solid electrolyte, which was dark contrast, was clear.

### REFERENCE SIGNS LIST

1 active material particle
2 oxide solid electrolyte
3 composite particle
4 sulfide solid electrolyte
11 electrolyte layer
12 cathode active material layer
13 anode active material layer
14 cathode current collector
15 anode current collector
16 cathode
17 anode
100a, 100b, 100c, 100d composite active material
200 lithium battery

What is claimed is:

1. A method for producing a composite active material comprising:
a preparation step of preparing composite particles comprising active material particles and an oxide solid electrolyte coating at least a part of the surfaces of the active material particles, wherein the active material particles comprise lithium, oxygen and at least one selected from the group consisting of cobalt, nickel, and manganese; and
a coating step of mixing the composite particles and a crystalline sulfide solid electrolyte while controlling a temperature of a mixture of the composite particles and the sulfide solid electrolyte to be no greater than 58.6° C. and while applying an energy to the mixture such that the sulfide solid electrolyte undergoes plastic deformation, such that the surfaces of the composite particles are coated with the sulfide solid electrolyte.

2. The method for producing the composite active material according to claim 1, wherein the mixing in the coating step comprises:
a first mixing step of carrying out the mixing under a condition such that the sulfide solid electrolyte undergoes plastic deformation; and
a second mixing step of carrying out the mixing under a condition such that the sulfide solid electrolyte does not undergo plastic deformation,
and wherein the first mixing step and the second mixing step are alternately carried out.

3. The method for producing the composite active material according to claim 2,
wherein the first mixing step is carried out for no longer than a time T at once in the coating step; and
in a curve which is a plot of a temperature increase of the mixture against an operation time of the first mixing step in a case where only the first mixing step is continuously carried out as the coating step, the time T is an operation time corresponding to an intersection of an extension line of a most rapid temperature increase right after beginning of the coating step and a tangential line which touches the curve at an operation time when the temperature increase per unit time converges.

4. The method for producing the composite active material according to claim 1,
wherein the crystalline sulfide solid electrolyte in the coating step is sulfide solid electrolyte particles having an average particle size of no greater than 1 μm.

5. The method for producing the composite active material according to claim 1, wherein the coating step further comprises the steps of:
adding the crystalline sulfide solid electrolyte to the mixture after mixing for 10 minutes or more; and thereafter
carrying out the mixing while controlling the temperature of the mixture to be no greater than 58.6° C. and while applying an energy to the mixture such that the sulfide solid electrolyte undergoes plastic deformation.

6. The method for producing the composite active material according to claim 1, further comprising:
a pretreatment step of mixing the composite particles and/or the crystalline sulfide solid electrolyte with a compound having an alkyl group, prior to the coating step.

7. A lithium battery comprising:
a cathode;
an anode; and
an electrolyte layer arranged between the cathode and the anode,
wherein the cathode and/or the anode comprises the composite active material produced by the method as in claim 1.
